(19) United States
(12) Patent Application Publication
(10) Pub. No.: US 2013/0254248 A1
(43) Pub. Date: Sep. 26, 2013

(54) Method And Apparatus For A Distributed File System In A Cloud Network

(71) Applicants: Hyunseok Chang, Holmdel, NJ (US); Muralidharan S. Kodialam, Marlboro, NJ (US); Tirunell V. Lakshman, Morganville, NJ (US); Sarit Mukherjee, Marlboro, NJ (US); Limin Wang, Plainsboro, NJ (US)

(72) Inventors: Hyunseok Chang, Holmdel, NJ (US); Muralidharan S. Kodialam, Marlboro, NJ (US); Tirunell V. Lakshman, Morganville, NJ (US); Sarit Mukherjee, Marlboro, NJ (US); Limin Wang, Plainsboro, NJ (US)

(73) Assignee: Alcatel-Lucent USA Inc., Murray Hill, NJ (US)

(21) Appl. No.: 13/427,958

(22) Filed: Mar. 23, 2012

(51) Int. Cl. G06F 17/30; G06F 15/167

(52) U.S. Cl. 707/827; 707/E17.01; 707/E17.032

(57) ABSTRACT

Various embodiments provide a method and apparatus of providing a distributed network file system in a cloud network that provides performance guarantees in cloud storage that are independent of the accessed files and the access locations. A client's file system is provisioned using a file placement strategy that is based on client's access locations and determined maximum access bandwidths and does not require knowledge of file access patterns.

### TECHNICAL FIELD

The invention relates generally to methods and apparatus for providing a distributed network file system in a cloud network.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known file systems, file access is achieved by having network attached storage connected to an enterprise network. In other known distributed network file systems, file access is achieved by striping files across different storage servers.

### SUMMARY

Various embodiments provide a method and apparatus of providing a distributed network file system in a cloud network that provides performance guarantees in cloud storage that are independent of the accessed files and the access locations. A client's file system is provisioned using a file placement strategy that is based on client's access locations and determined maximum access bandwidths without requiring knowledge of file access patterns. Advantageously, the distributed file system allows fast, ubiquitous and guaranteed access to the storage from all published access locations without requiring a service provider to ensure that the storage is accessible.

In one embodiment, an apparatus is provided for providing a distributed file system. The apparatus includes a data storage and a processor communicatively connected to the data storage. The processor is programmed to determine a plurality of client locations, the plurality of client locations associated with a plurality of files stored within a plurality of storage nodes within a storage network and the plurality of client locations communicatively connected to a plurality of edge node within the storage network via a plurality of associated communication channels; determine a plurality of access bandwidths of the plurality of associated communication channels; and provision storage of the plurality of files within the storage nodes based on the plurality of client locations and the plurality of access bandwidths.

In some embodiments, the provision of the storage of the plurality of files includes further programming the processor to apply file chunking and file replication storage mechanisms to the plurality of files based on the plurality of client locations and the plurality of access bandwidths, wherein the file chunking and file replication storage mechanisms specify storing the plurality of files as a plurality of file chunks; determine placement of the plurality of file chunks within the storage nodes based on the plurality of client locations and the plurality of access bandwidths; and determine for each of a select portion of the plurality of edge nodes at least one of the plurality of storage nodes to be accessed in response to a file access request received from each of a select portion of the plurality of client locations based on the plurality of client locations and the plurality of access bandwidths, wherein the select portion of the plurality of edge nodes are associated with the select portion of the plurality of client locations.

In some embodiments, applying the file chunking storage mechanism includes applying a uniform file chunking ratio across the plurality of files.

In some embodiments, the provision of the storage of the plurality of files includes further programming the processor to determine a plurality of second client locations, the plurality of second client locations associated with a plurality of second files stored within the plurality of storage nodes within the storage network and the plurality of second client locations communicatively connected to the plurality of edge node within the storage network via a plurality of second associated communication channels; determine a plurality of second access bandwidths of the plurality of second associated communication channels; and decline provisioning of the storage of the plurality of second files within the storage network based on the plurality of second client locations, the plurality of second access bandwidths, and a client service guarantee.

In some embodiments, the provision of the storage of the plurality of files includes further programming the processor to scale the client service guarantee based on the plurality of second client locations and the plurality of second access bandwidths; and provision storage of the plurality of second files within the storage nodes based on the plurality of second client locations and the plurality of second access bandwidths.

In some embodiments, the provision of the storage of the plurality of files includes programming the processor to determine a plurality of edge nodes associated with the plurality of client locations; apply at least one file storage mechanism to the plurality of files; and update the plurality of edge nodes with access information to access the plurality of files from a plurality of storage nodes within the storage network.

In some embodiments, the provision of the storage of the plurality of files includes further programming the processor to determine a plurality of communication paths within the storage network, the plurality of communication paths defining associated communication paths between the plurality of edge nodes and the plurality of storage nodes.

In some embodiments, the at least one file storage mechanism includes file chunking and file replication; the file chunking splits each of the plurality of files into at most p chunks; the file chunking ratio is uniform across the plurality of files; and the file replication creates r replication groups, each replication group including one or more of the plurality of storage nodes.

In some embodiments, file chunks are stored in storage nodes within the replication group based on a chunk id.

In some embodiments, all file chunks having the same chunk id are stored in the same storage node within the replication group.

In a second embodiment, an apparatus is provided for providing a distributed file system. The apparatus including a data storage and a processor communicatively connected to the data storage. The processor being programmed to receive a plurality of requests from a plurality of client locations to access a plurality of files stored in a plurality of storage nodes within a storage network, the plurality of client locations being associated with a client and the plurality of files; receive access information from a storage controller specifying how to access the plurality of files; receive an access request for a first file from a first client location; determine a plurality of determined storage nodes storing the first file and a plurality of communication paths to the determined storage nodes, the determinations being based on the client, the access information and the first file; and retrieve the first file from the determined storage nodes via the determined communication paths. Where the plurality of client locations comprises the first client location and the plurality of storage nodes comprises the plurality of determined storage nodes.

In some embodiments, the determined storage nodes are fixed based on the client associated with the plurality of files.

In a third embodiment, a system is provided for providing a distributed file system. The system includes a plurality of client locations, each of the plurality locations associated with one of a plurality of clients; a plurality of edge nodes communicatively connected to the plurality of client locations via a plurality of associated communication channels; a plurality of storage nodes communicatively connected to the plurality of edge nodes, the plurality of storage nodes storing a plurality of files, each of at least a portion of the plurality of files being associated with one of the plurality of clients; and a storage controller communicatively connected to the edge nodes. The storage controller is programmed to determine a plurality of determined client locations; determine a plurality of access bandwidths of the associated plurality of communication channels; and provision storage of the plurality of files within the plurality of storage nodes based on the plurality of determined client locations and the plurality of access bandwidths.

In a fourth embodiment, a method is provided for provisioning the storage of a plurality of files. The method includes determining a plurality of client locations, the plurality of client locations associated with a plurality of files stored within a plurality of storage nodes within a storage network and the plurality of client locations communicatively connected to a plurality of edge node within the storage network via a plurality of associated communication channels; determining a plurality of access bandwidths of the plurality of associated communication channels; and provisioning storage of the plurality of files within the storage nodes based on the plurality of client locations and the plurality of access bandwidths.

In some embodiments, the step of provisioning the storage of the plurality of files includes applying file chunking and file replication storage mechanisms to the plurality of files based on the plurality of client locations and the plurality of access bandwidths, wherein the file chunking and file replication storage mechanisms specify storing the plurality of files as a plurality of file chunks; determining placement of the plurality of file chunks within the storage nodes based on the plurality of client locations and the plurality of access bandwidths; and determining for each of a select portion of the plurality of edge nodes at least one of the plurality of storage nodes to be accessed in response to a file access request received from each of a select portion of the plurality of client locations based on the plurality of client locations and the plurality of access bandwidths, wherein the select portion of the plurality of edge nodes are associated with the select portion of the plurality of client locations.

In some embodiments, the step of applying the file chunking storage mechanism includes applying a uniform file chunking ratio across the plurality of files.

### BRIEF DESCRIPTION OF THE DRAWINGS

Various embodiments are illustrated in the accompanying drawings, in which:

FIG. 1 illustrates a cloud network that includes an embodiment of the distributed network file system 100 in a cloud network;

FIG. 2 schematically illustrates functional blocks of accessing files in the distributed network file system 200 provisioned by storage controller 220;

FIG. 3 depicts a flow chart illustrating an embodiment of a method 300 for a storage controller to provision the distributed network file system 100 of FIG. 1 or the distributed network file system 200 of FIG. 2;

FIG. 4 depicts a flow chart illustrating an embodiment of a method 400 for an edge node to service requests for files from a client location;

FIG. 5 depicts a flow chart illustrating an embodiment of a method 500 for a storage controller to provision a storage system as illustrated in step 360 of FIG. 3; and

FIG. 6 schematically illustrates an embodiment of various apparatus 600 such as one of edge nodes 140 of FIG. 1 or edge nodes 240 of FIG. 2, or storage controller 120 of FIG. 1 or storage controller 220 of FIG. 2.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Various embodiments provide a method and apparatus of providing a distributed network file system in a cloud network that provides performance guarantees in cloud storage that are independent of the accessed files and the access locations. A client's file system is provisioned using a file placement strategy that is based on client's access locations and determined maximum access bandwidths and does not require knowledge of file access patterns.

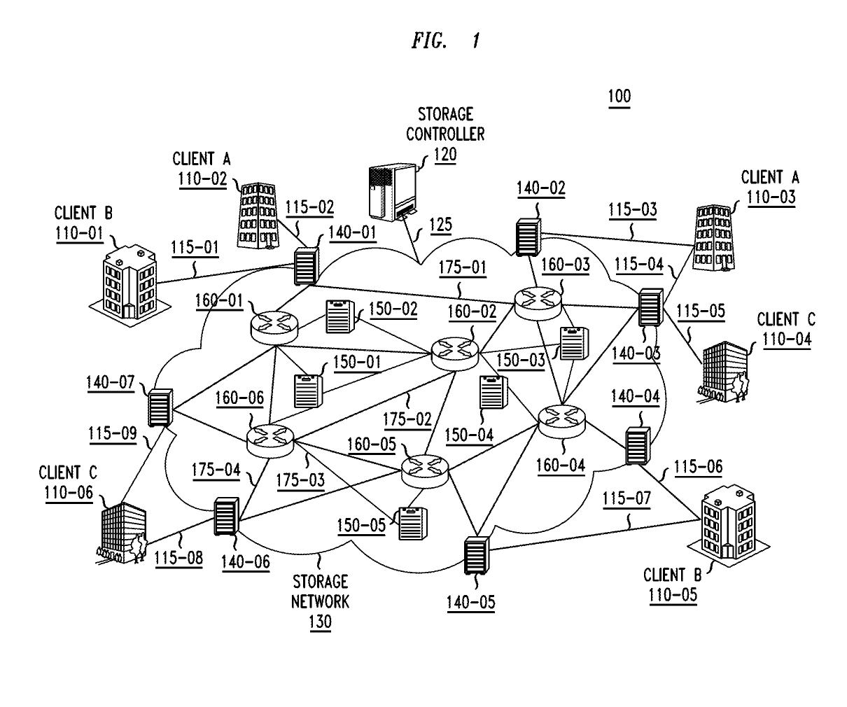

FIG. 1 illustrates a cloud network that includes an embodiment of a distributed network file system 100 in a cloud network. The distributed network file system 100 includes one or more client locations 110-01-110-06 (collectively, client locations 110), a storage controller 120 and a storage network 130. One or more client location communication channels 115-01-110-09 (collectively, client location communication channels 115) and a storage controller communication channel 125 connect the client locations 110 and storage controller 120 respectively to the storage network 130. The storage network 130 includes one or more edge nodes 140-01-140-07 (collectively, edge nodes 140) interconnected to one or more storage nodes 150-01-150-05 (collectively, storage nodes 150) via one or more network devices 160-01-160-06 (collectively, network devices 160) or one or more links 175-01-175-04 (collectively, links 175). The storage controller 120 determines the placement of files in storage nodes 150 and provides access information to edge nodes 140 for directing access of files from client locations 110.

Client locations 110 may include one or more locations for one or more clients. As illustrated in FIG. 1, Client A has client locations 110-02 and 110-03; Client B has client locations 110-01 and 110-05 and Client C has client locations 110-04 and 110-06. It should be appreciated that though depicted as three clients, there may be any number of clients and that though each client is depicted as having two client locations; each client may include any number of client locations. Client locations 110 may include any type or number of communication device(s) capable of sending or receiving files over one or more of client location communication channels 115. For example, a communication device may be a thin client, a smart phone, a personal or laptop computer, server, network device, tablet, television set-top box, media player or the like. Communication devices may rely on other resources within exemplary system to perform a portion of tasks, such as processing or storage, or may be capable of independently performing tasks. It should be appreciated that client locations may share the same geographic location (e.g., Client B 110-01 and Client A 110-02 may reside in the same building).

The term “file” as used herein means any client content controlled by a specific client (e.g., Client A) and should be understood broadly as including any content capable of being transmitted or received over client location communication channels 115. For example, files may include: conventional files, packets, a stream of packets, a digital document, video or image content, file blocks, data objects, any portion of the aforementioned, or the like.

Client location communication channels 115 provide a communicative connection between client locations 110 and the storage network 130 via associated edge nodes 140. In particular, a client location communication channel (e.g., 115-02) provides a guaranteed level of service between a client location (e.g., 110-02) and an edge node (e.g., 140-01). A guaranteed level of service may include a maximum bandwidth guarantee. It should be appreciated that client locations may share the same physical client location communication channel. For example, Client B 110-01 and Client A 110-02 may share a high speed broadband connection using a VPN tunnel for Client B 110-01 and a second VPN tunnel for client A 110-02.

The communication channels 115 and 125 and links 175 support communicating over one or more communication channels such as: wireless communications (e.g., LTE, GSM, CDMA, bluetooth); femtocell communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, communication channels 115, and 125 and links 175 may be any number or combinations of communication channels.

Storage controller 120 may be any apparatus that determines the placement of files in storage nodes 150 and provides access information to edge nodes 140 for directing access of files from client locations 110. In particular, the placement of files in storage nodes 150 is based on determined access locations (e.g., one or more of client locations 110) and determined access bandwidths (e.g., bandwidth guarantees of one or more client location communication channels interconnecting a client location (e.g., 110-02) and an edge node (e.g., 140-01)). It should be appreciated that while only one storage controller is illustrated here, system 100 may include more storage controllers.

The storage network 130 includes one or more edge nodes 140 interconnected to one or more storage nodes 150 via one or more network devices 160 or one or more links 175.

It should be appreciated that though only four links, 175-01-175-04 are labeled in storage network 130, all of the links interconnecting edge nodes 140, storage nodes 150 and network devices 160 are members of links 175 and those remaining labels have been omitted for the purpose of clarity. It should be further appreciated that storage network 130 may include any number of edge nodes 140, storage nodes 150 and network devices 160 and any number and configuration of links 175. Moreover, it should be appreciated that storage network 130 may include any combination and any number of wireless, wire line or femtocell networks including: LTE, GSM, CDMA, Local Area Network(s) (LAN), Wireless Local Area Network(s) (WLAN), Wide Area Network (WAN), Metropolitan Area Network (MAN), or the like.

Edge nodes 140 may be any apparatus that acts as a gateway for one of client locations 110 into the storage network 130. In particular, one of edge nodes 140 receives a request for a file (e.g., a file read or write request received over 115-02) and directs the file access request to the one or more storage nodes 150 storing the requested file. It should be appreciated that while seven edge nodes are illustrated here, system 100 may include fewer or more edge nodes.

Storage nodes 150 store the files and provide conventional storage services. Storage nodes 150 may be any suitable storage device and may include any number of storage devices. The included storage device(s) may be similar or disparate and/or may be local to each other or geographically dispersed. It should be appreciated that while five storage nodes are illustrated here, system 100 may include fewer or more storage nodes.

Network devices 160 route the requests and files through storage network 130. Network devices 160 may be any suitable network device including: routers, switches, hubs, bridges, or the like. The included network device(s) may be similar or disparate and/or may be local to each other or geographically dispersed. It should be appreciated that while six network devices are illustrated here, system 100 may include fewer or more network devices.

In some embodiments, one or more of client locations 110 are enterprise locations employing conventional virtual private network services and one or more of client location communication channels 115 are VPN tunnels.

In some embodiments, storage controller 120 may be a part of storage network 130. In a further embodiment of this embodiment, one or more of edge nodes 140 may provide the functionality of the storage controller 120. In some embodiments, storage controller 120 employs file storage mechanisms such as data replication and data chunking. Advantageously, file storage mechanisms may mitigate congestion bottlenecks within storage network 130. A first file storage mechanism, data replication, includes distributing the network load across various links by storing multiple copies of files at different storage nodes 150. Advantageously, by using data replication, the load from file access requests may be provisioned across the various portions of storage network 130 such as the storage nodes 150, the network devices 160 and the links 175. A second file storage mechanism, data chunking, includes splitting a file into several smaller chunks which may be stored at different storage nodes. Subsequently, when a file is requested, all of the chunks are downloaded to the user. Advantageously, chunking enables the load from file access requests to be distributed across the storage network 130.

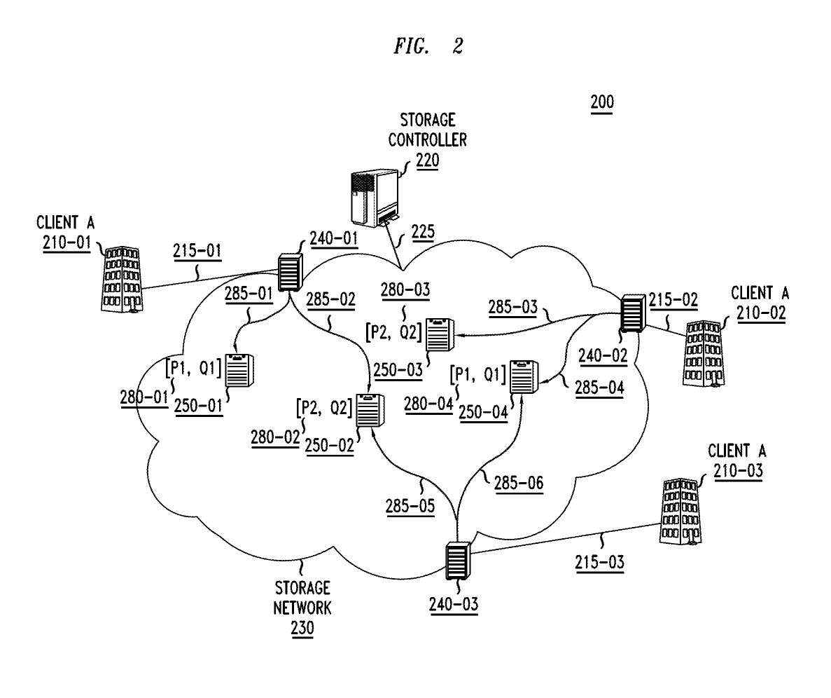

FIG. 2 schematically illustrates functional blocks of accessing files chunks 280-01-280-04 (collectively, file chunks 280) in the distributed network file system 200 provisioned by storage controller 220. The system includes one client (e.g., Client A) which has three (3) client locations 210-01-210-03 (collectively, client locations 210). Client locations 210 communicate with respective edge nodes 240-01-240-03 (collectively, edge nodes 240) via respective client location communication channels 215-01-215-03 (collectively, client location communication channels 215). Edges nodes 240 communicate with storage nodes 250-01-250-04 (collectively, storage nodes 250) via associated communication paths 285-01-285-06 (collectively, communication paths 285).

Client locations 210 are three exemplary locations of Client A that accesses files in the storage network 230 as described in FIG. 1.

Client location communication channels 215 are three exemplary client location communication channels that communicatively connect client locations 210 with respective edge nodes 240 as described in FIG. 1.

Storage controller 220 provisions a client's files (e.g., file chunks 280) within the storage network 230 as described in FIG. 1.

Edge nodes 240 and storage nodes 250 function as described in FIG. 1.

File chunks 280 illustrate at least a portion of the client's files. In this example, file chunks 280 represent the storage of two client files, P and Q within the storage network 230. In this example, data replication and data chunking are used. First, the files are chunked into two segments and each chunk is replicated in two locations. As illustrated, file P is chunked into segments P1 and P2 and chunk P1 is stored in storage nodes 250-01 and 250-04 while chunk P2 is stored in storage nodes 250-02 and 250-03.

Communication paths 285 communicatively connect edge nodes 240 with associated storage nodes 250. For example, edge node 240-01 is communicatively connected to storage node 250-01 via communication path 285-01 and to storage node 250-02 via communication path 285-02. In particular, communication paths 285-01-285-06 include the appropriate network devices and links (e.g., network devices 160 and links 175 of FIG. 1) of the communication path (e.g., 285-01) provisioned by storage controller 220 for an edge node (e.g., 240-01) to access a storage node (e.g., 250-01) in order to retrieve file chunks (e.g., file chunk P1 of file chunks 280-01).

In some embodiments, the file chunks 280 stored in the storage network 230 represents a set of files. It should be appreciated that the set of files in the system may be dynamic.

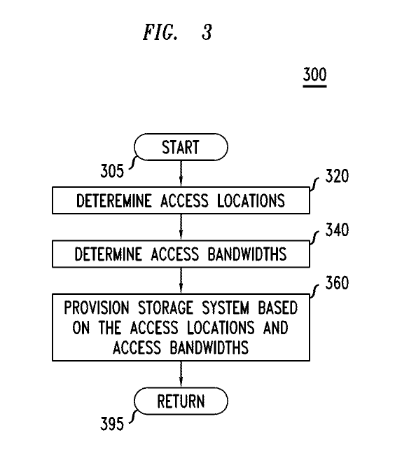

FIG. 3 depicts a flow chart illustrating an embodiment of a method 300 for a storage controller (e.g., storage controller 120 of FIG. 1 or storage controller 220 of FIG. 2) to provision the distributed network file system 100 of FIG. 1 or the distributed network file system 200 of FIG. 2. The method includes determining: (i) client access locations (step 320); and (ii) access bandwidths (step 330). The apparatus performing the method then provisions the storage network (e.g., storage network 130 of FIG. 1 or storage network 230 of FIG. 2) based on the determined access locations and access bandwidths (step 360) without requiring prior knowledge of file access patterns.

In the method 300, the step 320 includes determining access locations such as client locations 110 of FIG. 1 or client locations 220 of FIG. 2. In particular, client locations from which access requests will originate for files of a specified client are determined. For example, for client files of Client A in FIG. 1, determined client locations may be 110-02 and 110-03. Similarly, for files of Client A in FIG. 2, determined client locations may be 210-01-210-03. It should be appreciated that some client locations (e.g., for purposes of this example, client location 210-02 of FIG. 2) may not access the files and thus, may not be a determined client location.

In the method 300, the step 340 includes determining access bandwidths between the determined client locations and respective one or more edge nodes. Referring to FIG. 1, client location communication channels 115-02, 115-03 and 115-04 may be VPN tunnels with pre-negotiated bandwidth guarantees for the VPN service. Similarly, referring to FIG. 2, client location communication channels 215-01-215-03 may be VPN tunnels with pre-negotiated bandwidth guarantees for the VPN service. As such, the determined access bandwidths may be based on the pre-negotiated bandwidth guarantees.

In the method 300, the step 360 includes provisioning the cloud-base storage system 100 based on the determined client access locations and determined access bandwidths. In particular, referring to FIG. 2, the file storage mechanism(s) is determined and for determined client locations (e.g., client locations 210-01-210-03) the apparatus performing the method: (i) optionally determines the edge node(s) (e.g., edge nodes 240) via which each of the selected client locations will access the storage network (e.g., storage network 230); (ii) applies the file storage mechanism(s) to the files (e.g., chunks and replicates files into file chunks 280 and determines which file chunks are stored at which storage nodes (e.g., storage nodes 250)); (iii) optionally determines the path that each of the determined client locations or edge nodes will access the client files (e.g., communication paths 285); and (iv) optionally updates the appropriate edge nodes (e.g., edge nodes 240) with the access communication information. It should be appreciated that the edge node(s) determined in step (i) above may be the geographically closest edge node to the client location or a previously selected edge node (e.g., determined during business negotiations). In some of these embodiments, the determination in step (i) may include retrieving the previously selected edge node(s).

Advantageously, by provisioning a portion of the storage nodes (e.g., storage nodes 150 of FIG. 1 or storage nodes 250 of FIG. 2) to create virtual storage for the sole use of a client (e.g., Client A of FIG. 1 or 2) with bandwidth guarantees for the client user's accessing the files, an enterprise grade service may be provided.

In some embodiments, the step 320 includes selecting storage nodes (e.g., storage nodes 250-01 and 250-02) closest to the edge node (e.g., edge node 240-01) from which to retrieve the file chunks. In some other embodiments, other strategies, such as tunneling into a specific storage node which may be farther away, may select storage nodes that are not the closest to the edge node.

In some embodiments of the step 360, file storage mechanisms include chunking and replication. Advantageously, these mechanisms may enable an access oblivious scheme. In some of these embodiments, each file stored in the storage network (e.g., storage network 230 of FIG. 2) is chunked into at most p chunks and each of these chunks is replicated r times, creating at most p×r file chunks in the storage network. In some of these embodiments, the chunking ratio is substantially uniform across the file chunks. For example, referring to FIG. 2, the ratio “r” of size(P1)/size(P2) substantially equals the ratio of size(Q1)/size(Q2). Advantageously, the ratio of traffic between the edge node and storage node communication paths (e.g., “traffic on 285-01”/“traffic on 285-02”) may approximate the ratio “r” making the storage provisioning oblivious to the actual file access patterns.

In some embodiments of the step 360, the access communication information includes directing from which storage nodes an edge node is to retrieve the file chunks. For example, referring to FIG. 2, for a request originating from client location 210-01, edge node 240-01 is directed to retrieve the two file chunks P1 and P2 from storage node 250-01 and 250-02 respectively.

In some embodiments of the step 360, the access communication includes directing the access communication path an edge node is to use in retrieving the file chunks. For example, referring to FIG. 2, for a request originating from client location 210-01, edge node 240-01 is directed to retrieve the two file chunks P1 and P2 from the storage nodes using access communication paths 285-01 and 285-02 respectively.

In some embodiments of the step 360, the provisioning includes incorporating conventional failover, recovery, load balancing or redundancy techniques during the application of the file storage mechanisms. In these embodiments, the application of the file storage mechanisms incorporates these techniques so as not to violate the guaranteed level of service (e.g., guaranteed bandwidths).

Advantageously, by selecting a set of storage nodes for housing the files in a way that provides guaranteed access to the files without a priori knowledge of user access pattern, access location and actual accessed files, the system (e.g., distributed network file system 100 of FIG. 1) may be:
Access oblivious as file placement is not required to change with dynamic user requests. New users can join at client locations and new client files may be ingested into the cloud so long as the bandwidth demands remain within the guaranteed service limits. Storage node bottlenecks and storage network link bottlenecks are independent of the client files being accessed.
Cost efficient as the system does not require constant monitoring and shuffling the client files to meet performance requirements with changing access patterns.
Efficient new client admission determinations as admission determinations may grant the required performance guarantees without requiring prior knowledge of file access patterns.

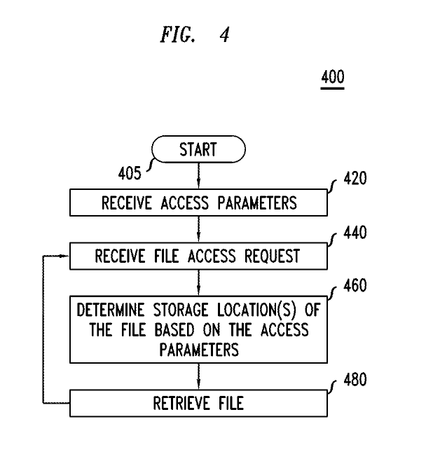

FIG. 4 depicts a flow chart illustrating an embodiment of a method 400 for an edge node (e.g., one of edge nodes 240-01-240-03 of FIG. 2) to service requests for files (e.g., file P or Q of FIG. 2) from a client location (e.g., one of client locations 210-01-210-03 of FIG. 2). The method includes receiving access parameters from a storage controller (step 420). The apparatus performing the method then uses the access parameters to determine storage location(s) (step 460) of requested files (step 440) and retrieves the requested file (step 480) from the determined storage locations.

In the method 400, the step 420 includes receiving access parameters from a storage controller (e.g., storage controller 220 of FIG. 2). In particular, the access parameters specify the storage node(s) (e.g., storage nodes 250 of FIG. 2) where the file resides for the requesting client location (e.g., client locations 210 of FIG. 2). In some embodiments, the access parameters also specify the communication path (e.g., communication paths 285 of FIG. 2) to use in retrieving the client file.

In the method 400, step 440 includes receiving a request to access a client file from a client location. In particular, referring to FIG. 2, the edge node (e.g., edge node 240-01) acts as a gateway receiving access requests over the client location communication channel (e.g., 215-01) for files (e.g., file P) from a client location (e.g., client location 210-01).

In the method 400, step 460 includes using the received access parameters to determine the storage node(s) (e.g., storage nodes 250 in FIG. 2) in which the requested client segment (e.g., file P in FIG. 2) is stored.

In the method 400, step 480 includes retrieving the file from the determined storage node(s). In particular, referring to FIG. 2, the edge node (e.g., edge node 240-01) retrieves the chunks of a file (e.g., P1 of 280-01 and P2 of 280-02) from the determined storage node(s) (e.g., storage nodes 250-01 and 250-02) and delivers the reconstructed file to the requesting user at the client location (e.g., client location 210-01).

In some embodiments of the step 420, the edge node performing the method maintains a table per client (e.g., Client A of FIG. 2) that directs the edge node to the storage node(s) that contain the client file.

In some embodiments of the step 420, the edge node performing the method maintains a table per client that directs the edge node to which access communication path(s) should be used in retrieving the client file.

In some embodiments of the step 460, the storage node(s) that an edge node accesses for a particular client (e.g., Client A of FIGS. 1 and 2) is fixed regardless of the client file being accessed.

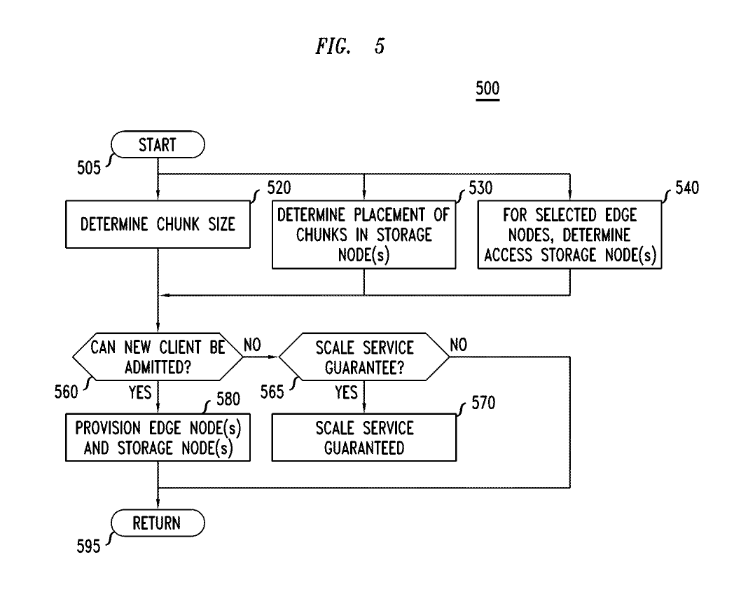

FIG. 5 depicts a flow chart illustrating an embodiment of a method 500 for a storage controller (e.g., storage controller 120 of FIG. 1) to provision a storage system as illustrated in step 360 of FIG. 3. The method includes determining chunk size (step 520), determining placement of chunks in storage node(s) (step 530), and for selected edge nodes, determining the access storage node(s) (step 540). The apparatus performing the method also optionally determines whether the new client may be admitted (step 560) and optionally scales the guaranteed rate (570) if a scale service is available (step 565). The scale service allows the new client to be admitted using a scaled guaranteed level of service. The apparatus performing the method may also provision the edge node(s) and storage node(s) based on the determinations (step 580).

In the method 500, the step 520 includes determining chunk size. In particular, a chunk size for client files is determined as described in FIG. 3.

In the method 500, the step 530 includes determining placement of the file chunks in storage node(s) as described in FIG. 3.

In the method 500, the step 540 includes for selected edge node(s), determining access storage node(s). In particular, the storage node(s) (e.g., storage nodes 150 in FIG. 1 and storage nodes 250 in FIG. 2) containing the client files are associated with selected edge node (e.g., edge nodes 140 in FIG. 1 and edge nodes 240 of FIG. 2).

The method 500 optionally includes step 560. Step 560 includes determining whether the new client may be admitted. In particular, a new client is admitted by the cloud service provider if there is sufficient bandwidth available to process any access pattern for the files. If the new client may be admitted, the method proceeds to step 580, else the method proceeds to step 565.

The method 500 optionally includes step 565. Step 565 includes determining whether the requesting client's service guarantees may be adjusted in order that the client may be admitted. If the service guarantees may be adjusted, the method proceeds to step 570, else the method ends (step 595). It should be appreciated that in some embodiments, the scaling service may not be provided. In these embodiments, step 560 may end (step 595) if there is a determination that the new client is not able to be admitted.

The method 500 optionally includes step 570. Step 570 includes scaling the requesting client's service guarantees in order that the client may be admitted. For example, if there would be sufficient bandwidth available to process any access pattern for the files if the bandwidth is 90% of the maximum guaranteed bandwidth, then the maximum guaranteed bandwidth is scaled back by a factor of 90%.

In the method 500, the step 580 includes provisioning the edge node(s) and storage node(s) as described in FIG. 3.

It should be appreciated that though described with reference to a newly added client, the method may also be applied to updating a client's storage provisioning. In these embodiments, step 560 determines whether the updated client storage requirements may be satisfied and if not, may scale back the updated client storage requirements or revert back to the prior client storage requirements.

In some embodiments of the steps 520, 530 or 540, the location of the storage nodes are fixed and known.

In some embodiments of the method 500, steps 520, 530, 540 or 570 may be determined concurrently. For example, the parameters determined in steps 520, 530, and 540 may be solved for in the same algorithm and the scale factor of step 570 may be based on the result.

In some embodiments of the method 500, steps 565 and 570 may be executed concurrently. For example, the decision on whether a client will allow scaling may require that the decision be based on the scale factor.

In some embodiments of the steps 520, 530 or 540, the maximum rate at which client files may be accessed at an edge node (e.g., one of edge nodes 140 of FIG. 1 or 240-01-240-03 of FIG. 2) is upper bounded. In some of these embodiments, the upper bound is the capacity of the client location communication channel (e.g., one of client location communication channels 115 of FIG. 1 or 215-01-215-03 of FIG. 2). Advantageously, using pre-negotiated client location communication channel bandwidth guarantees allows a client (e.g., Client A of FIG. 1 or FIG. 2) to renegotiate the service levels by either augmenting or cutting back the bandwidth rate at different client location communication channels.

In some embodiments of steps 520, 530 or 540, access communications paths (e.g., communication paths 285-01-285-06 in FIG. 2) are determined using conventional shortest path routing techniques. In some of these embodiments, each link “e” (e.g., one of links 175 in FIG. 1) in the storage network (e.g., storage network 130 in FIGS. 1 and 230 in FIG. 2) has a link capacity of c(e) and a link weight metric w(e) that is used for shortest path computation. The capacity of link e is the currently available capacity on the link. This is the original link capacity reduced by the bandwidth reservations made for all the accepted clients that use link e to access data (e.g., Clients Client A, Client B and Client C of FIG. 1).

In some embodiments, the step 560 includes updating the link capacities of the links of the storage network (e.g., links 175 of storage network 130 in FIG. 1) based on the added bandwidth requirements of the newly added or updated client (e.g., Client A in FIG. 1).

In some embodiments, the step 560 includes determining whether a bandwidth requirement can be met. In some of these embodiments, the bandwidth requirement is for downloading or uploading a file. In some of these embodiments, there exists a quality of service agreement between the client (e.g., Client A of FIGS. 1 and 2) and the cloud storage provider. For example, the quality of service agreement may guarantee that a file is capable of being downloaded within a fixed time or specify the minimum rate at which the file will be downloaded.

In some of these embodiments, equation E.1 may be used in determining the total bandwidth requirement at an edge node (e.g., one of edge nodes 140 of FIG. 1).

$${\sum }_{f ∈ F} {N}_{u}^{f} ( t ) {R}^{f} \leq {D}_{u} ∀ u , t \qquad [ E .1 ]$$

In equation [1], R^{f} denotes the download rate for a file “f” and Nᵤ^{f}(t) represents the number of requests for file f being transmitted to the edge node “u” at time t. Dᵤ denotes the maximum download rate at edge node “u”.

In some embodiments, the steps 520, 530, or 540 include solving a linear programming problem using conventional classical optimization techniques. Conventional classical optimization techniques involve determining the action that best achieves a desired goal or objective. An action that best achieves a goal or objective may be determined by maximizing or minimizing the value of an objective function. In some embodiments, the goal or metric of the objective function may be to minimize the maximum link utilization.

The problem may be represented as:

$$\begin{matrix}Optimizing \text{:} \\ y = f ( {x}_{1} , {x}_{2} , … , {x}_{n} ) & [ E .2 ] \\ Subject to \text{:} \\ {G}_{j} ( {x}_{1} , {x}_{2} , … , {x}_{n} ) \{ \begin{matrix}\leq \\ = \\ \geq \end{matrix} \} {b}_{j} \\ j = 1 , 2 , … m & [ E .3 ]\end{matrix}$$

Where the equation E.2 is the objective function and equation E.3 constitutes the set of constraints imposed on the solution. The xᵢ variables, x₁, x₂, . . . , xₙ, represent the set of decision variables and y=f(x₁, x₂, . . . , xₙ) is the objective function expressed in terms of these decision variables. It should be appreciated that the objective function may be maximized or minimized.

In some embodiments of steps 520, 530 or 540, a first embodiment using a linear programming problem includes splitting files into the same number of chunks and replicating the files “r” times. In some embodiments, the constraint Σₖβₖ=1 is applied to ensure that the entire file is chunked. In the constraint, βₖ represents the fraction of each file that is in chunk k. In some embodiments, the constraint βₖ≧1/p is also applied in order to ensure that each file is split into at most “p” chunks.

In some embodiments of the first embodiment, each replica “j” of chunk “k” is placed in the same storage node. For example, referring to FIG. 2, storage node 250-01 contains the k=1 chunks for the j=1 replicas of files P and Q and storage node 250-02 contains the k=2 chunks for the j=1 replicas of files P and Q.

In some embodiments of the first embodiment, the linear programming decision variables are the size of the chunks and the location of the storage node where each replica of each chunk is placed. Using |C| to denote the number of storage nodes and “r” to denote the number of replications of each chunk, there are

$$q = ( \begin{matrix}\vert C \vert \\ r\end{matrix} )$$

possible replication groups “G”. Where Gⱼ represents the set of r storage nodes in replication group j. In some of these embodiments, if chunk k is stored in replication group Gⱼ, then each storage node “c”εGⱼ stores chunk k of every file. In order to keep notation simple, chunk id and the replication group id are the same. For example, chunk j is stored in replication group Gⱼ.

In some embodiments of the first embodiment, when an edge node “u” accesses (e.g., download or upload) a fraction βⱼ of a file from replication group j, the access is done from the storage node “c”εGⱼ that is closest to the edge node u. As such, edge node u accesses a file fraction βⱼ from storage node cεGⱼ such that |SP(c; u)|≦|SP(c′; u)| for all c′εGⱼ. In this equation, SP( . . . ; . . . ) denotes the shortest path between the edge node—storage node pair. Similarly, SP(Gⱼ; u) is used to denote the set of links in SP(c; u) where storage node c is the closest storage node in Gⱼ to edge node u. It should be appreciated that accessing the client data from the closest storage node containing the file chunk may be extended to solve for the case where the file can be accessed from multiple storage nodes in the same replication group.

Since each edge node accesses a fraction βⱼ of every file from replication group j, the total flow rate from replication group j to an edge node u at time t is Σ_{fεF}βⱼNᵤ^{f}(t)R^{f} where Nᵤ^{f}(t) represents the number of copies of file f being transmitted to edge node u at time t. From Equation [1] we can write:

$$\begin{matrix}{\sum }_{f ∈ F} {β}_{j} {N}_{u}^{f} {R}^{f} = {β}_{j} {\sum }_{f ∈ F} {N}_{u}^{f} ( t ) {R}^{f} & [ E .4 ] \\ \leq {β}_{j} {D}_{u} ∀ u , t & [ E .5 ]\end{matrix}$$

In equations [4] and [5], βⱼ denotes a file fraction, R^{f} denotes the download rate for a file “f” and Nᵤ^{f}(t) represents the number of requests for file f being transmitted to the edge node “u” at time t. Dᵤ denotes the maximum download rate at edge node “u”.

From equations [4] and [5], the amount of capacity to be provisioned from replication group j to edge node u is upper bounded by βⱼDᵤ. Letting H(e) denote the set of (replication group, edge node) pairs that use link e to access files (i.e., H(e)={(Gⱼ, u):eεSP(Gⱼ, u)}), the maximum flow on link e will then be Σ_{(G}_{ⱼ}_{,u)εH(e) β}ⱼDᵤ. It should be appreciated that the selected set of (replication group, edge node) pairs (i.e., H(e)) specifies the determined storage nodes for the selected edge nodes (e.g., step 540).

In some embodiments of the first embodiment, the objective of the linear programming problem is to determine how the files are chunked (step 520) and where these chunks are replicated (step 530) in order to minimize the maximum link utilization represented by λ. The linear programming problem to determine these parameters may be the following:

$$\begin{matrix}min λ & [ E .6 ] \\ {\sum }_{( {G}_{j} , e ) ∈ H ( e )} {β}_{j} {D}_{u} \leq λ c ( e ) ∀ e ∈ E & [ E .7 ] \\ {\sum }_{j} {β}_{j} = 1 & [ E .8 ] \\ {β}_{j} \geq \frac{1}{p} ∀ j & [ E .9 ]\end{matrix}$$

In equations [6]-[9], βⱼ denotes a file fraction, Dᵤ denotes the maximum download rate at edge node “u”, λ denotes the maximum link utilization, c(e) denotes the bandwidth capacity of link e where e is a member of the set of links E, j denotes the chunk number and replication group number, Gⱼ denotes the replication group of storage nodes, H(e) denotes the set of (replication group, edge node) pairs that use link e to access files, and p denotes the maximum number of chunks.

As such, in the first embodiment, the determined chunk size (step 520) is βⱼ; the determined placement of chunks in the storage node(s) (step 530) is given by G where for each replication group Gⱼ, each storage node cεGⱼ stores chunk j of every file; and the determined access storage nodes for each selected edge node (step 540) is given by the set of replication group—edge node pairs (i.e., (Gⱼ,u)) in H(e).

Furthermore, in the first embodiment, the client admission decision (step 560) may be derived from the minimum maximum link utilization λ. If λ≦1, then the client may be admitted with the access oblivious service guarantee. If λ>1, then the client may not be admitted with the access oblivious service guarantee unless the storage controller determines that the service guarantee may be scaled (step 565). To enable client admission with an access oblivious service guarantee, the service guarantee may be scaled down by λ at each edge node u (step 570). For example, if the service guarantee is an access rate such as a maximum download rate, then the maximum download rate may be scaled down to Dᵤ/λ at each edge node u.

It should be appreciated that storage amount constraints at any of the storage nodes may be incorporated into the linear programming formulation by the addition of additional constraints.

Although primarily depicted and described in a particular sequence, it should be appreciated that the steps shown in methods 300, 400 and 500 may be performed in any suitable sequence. Moreover, the steps identified by one step may also be performed in one or more other steps in the sequence or common actions of more than one step may be performed only once.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

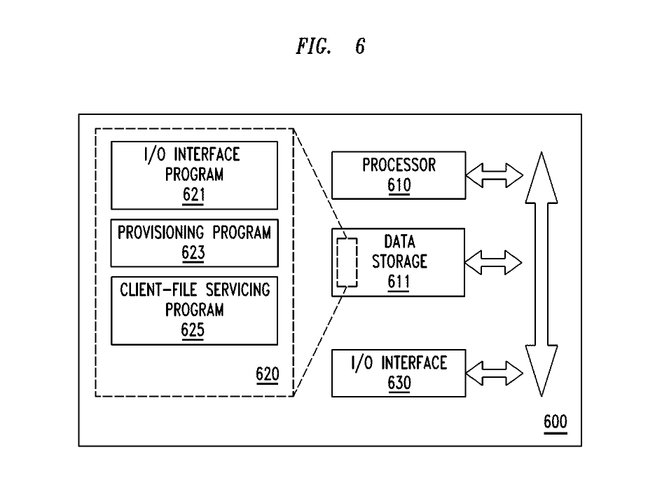

FIG. 6 schematically illustrates an embodiment of various apparatus 600 such as one of edge nodes 140 of FIG. 1 or edge nodes 240 of FIG. 2, or storage controller 120 of FIG. 1 or storage controller 220 of FIG. 2. The apparatus 600 includes a processor 610, a data storage 611, and an I/O interface 630.

The processor 610 controls the operation of the apparatus 600. The processor 610 cooperates with the data storage 611.

The data storage 611 may store program data such as routing information or the like as appropriate. The data storage 611 also stores programs 620 executable by the processor 610.

The processor-executable programs 620 may include an I/O interface program 621, a provisioning program 623, or a client file servicing program 625. Processor 610 cooperates with processor-executable programs 620.

The I/O interface 630 cooperates with processor 610 and I/O interface program 621 to support communications over communications channels 115, 125 or 175 of FIG. 1 or 215 or 225 and links communication path 285 of FIG. 2 as appropriate and as described above.

The provisioning program 623 performs the steps of method(s) 300 of FIG. 3 or 500 of FIG. 5 as described above.

The client file servicing program 625 performs the steps of method 400 of FIG. 4 as described above.

In some embodiments, the processor 610 may include resources such as processors/CPU cores, the I/O interface 630 may include any suitable network interfaces, or the data storage 611 may include memory or storage devices. Moreover the apparatus 600 may be any suitable physical hardware configuration such as: one or more server(s), blades consisting of components such as processor, memory, network interfaces or storage devices. In some of these embodiments, the apparatus 600 may include cloud network resources that are remote from each other.

In some embodiments, the apparatus 600 may be virtual machine. In some of these embodiments, the virtual machine may include components from different machines or be geographically dispersed. For example, the data storage 611 and the processor 610 may be in two different physical machines.

When processor-executable programs 620 are implemented on a processor 610, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

1. An apparatus for providing a distributed file system, the apparatus comprising:
a data storage; and
a processor communicatively connected to the data storage, the processor being configured to:
determine a plurality of client locations, associated with a client, a plurality of files and communicatively connected to a plurality of edge nodes within a storage network via a plurality of associated communication channels, the plurality of files stored within a plurality of storage nodes within the storage network;
determine a plurality of access bandwidths of the plurality of associated communication channels; and
provision storage of the plurality of files within the storage nodes based on the plurality of client locations and the plurality of access bandwidths.

2. The apparatus of claim 1, wherein the provision of the storage of the plurality of files comprises configuring the processor to:
apply file chunking and file replication storage mechanisms to the plurality of files based on the plurality of client locations and the plurality of access bandwidths, wherein the file chunking and file replication storage mechanisms specify storing the plurality of files as a plurality of file chunks;
determine placement of the plurality of file chunks within the storage nodes based on the plurality of client locations and the plurality of access bandwidths; and
determine for each of a select portion of the plurality of edge nodes at least one of the plurality of storage nodes to be accessed in response to a file access request received from each of a select portion of the plurality of client locations based on the plurality of client locations and the plurality of access bandwidths, wherein the select portion of the plurality of edge nodes are associated with the select portion of the plurality of client locations.

3. The apparatus of claim 2, wherein applying the file chunking storage mechanism includes applying a substantially uniform file chunking ratio across the plurality of files.

4. The apparatus of claim 2, wherein the provision of the storage of the plurality of files comprises further configuring the processor to:
determine a plurality of second client locations, the plurality of second client locations associated with a plurality of second files stored within the plurality of storage nodes within the storage network and the plurality of second client locations communicatively connected to the plurality of edge node within the storage network via a plurality of second associated communication channels;
determine a plurality of second access bandwidths of the plurality of second associated communication channels; and
decline provisioning of the storage of the plurality of second files within the storage network based on the plurality of second client locations, the plurality of second access bandwidths, and a client service guarantee.

5. The apparatus of claim 4, wherein the provision of the storage of the plurality of files comprises further configuring the processor to:
scale the client service guarantee based on the plurality of second client locations and the plurality of second access bandwidths; and
provision storage of the plurality of second files within the storage nodes based on the plurality of second client locations and the plurality of second access bandwidths.

6. The apparatus of claim 1, wherein the provision of the storage of the plurality of files comprises configuring the processor to:
determine a plurality of edge nodes associated with the plurality of client locations;
apply at least one file storage mechanism to the plurality of files; and
update the plurality of edge nodes with access information specifying access of the plurality of files from the plurality of storage nodes.

7. The apparatus of claim 6, wherein the provision of the storage of the plurality of files comprises further configuring the processor to:
determine a plurality of communication paths within the storage network, the plurality of communication paths defining associated communication paths between the plurality of edge nodes and the plurality of storage nodes.

8. The apparatus of claim 6,
wherein the at least one file storage mechanism includes file chunking and file replication;
wherein the file chunking splits each of the plurality of files into at most p chunks;
wherein the file chunking ratio is substantially uniform across the plurality of files; and
wherein the file replication creates r replication groups, each replication group including one or more of the plurality of storage nodes.

9. The apparatus of claim 8, wherein file chunks are stored in storage nodes within the replication group based on a chunk id.

10. The apparatus of claim 9, wherein all file chunks having the same chunk id are stored in the same storage node within the replication group.

11. An apparatus for providing a distributed file system, the apparatus comprising:
a data storage; and
a processor communicatively connected to the data storage, the processor being configured to:
receive a plurality of requests from a plurality of client locations to access a plurality of files stored in a plurality of storage nodes within a storage network, the plurality of client locations being associated with a client and the plurality of files;
receive access information from a storage controller specifying how to access the plurality of files;
receive an access request for a first file from a first client location;
determine a plurality of determined storage nodes storing the first file and a plurality of communication paths to the determined storage nodes, the determinations being based on the client, the access information and the first file; and
retrieve the first file from the determined storage nodes via the determined communication paths;
wherein the plurality of client locations comprises the first client location; and
wherein the plurality of storage nodes comprises the plurality of determined storage nodes.

12. The apparatus of claim 11, wherein the determined storage nodes are fixed based on the client associated with the plurality of files.

13. A system for providing a distributed file system, the system comprising:
a plurality of client locations associated with a client;
a plurality of edge nodes communicatively connected to the plurality of client locations via a plurality of associated communication channels;
a plurality of storage nodes communicatively connected to the plurality of edge nodes, the plurality of storage nodes storing a plurality of files, each of at least a portion of the plurality of files being associated with the client; and
a storage controller communicatively connected to the edge nodes, the storage controller configured to:
determine a plurality of determined client locations;
determine a plurality of access bandwidths of the associated plurality of communication channels; and
provision storage of the plurality of files within the plurality of storage nodes based on the plurality of determined client locations and the plurality of access bandwidths.

14. A method for providing a distributed file system, the method comprising:
at a processor communicatively connected to a data storage, determining a plurality of client locations associated with a client, a plurality of files and communicatively connected to a plurality of edge nodes within a storage network via a plurality of associated communication channels, the plurality of files stored within a plurality of storage nodes within the storage network
determining, by the processor in cooperation with the data storage, a plurality of access bandwidths of the plurality of associated communication channels; and
provisioning, by the processor in cooperation with the data storage, storage of the plurality of files within the storage nodes based on the plurality of client locations and the plurality of access bandwidths.

15. The method of claim 14, wherein the step of provisioning of the storage of the plurality of files comprises:
applying file chunking and file replication storage mechanisms to the plurality of files based on the plurality of client locations and the plurality of access bandwidths, wherein the file chunking and file replication storage mechanisms specify storing the plurality of files as a plurality of file chunks;
determining placement of the plurality of file chunks within the storage nodes based on the plurality of client locations and the plurality of access bandwidths; and
determining for each of a select portion of the plurality of edge nodes at least one of the plurality of storage nodes to be accessed in response to a file access request received from each of a select portion of the plurality of client locations based on the plurality of client locations and the plurality of access bandwidths, wherein the select portion of the plurality of edge nodes are associated with the select portion of the plurality of client locations.

16. The method of claim 15, wherein the step of applying the file chunking storage mechanism comprises applying a substantially uniform file chunking ratio across the plurality of files.
